(19) United States
(12) Patent Application Publication
(10) Pub. No.: US 2014/0360267 A1
(43) Pub. Date: Dec. 11, 2014

(54) THERMAL CONVECTION TYPE LINEAR ACCELEROMETER

(71) Applicant: CHUNG HUA UNIVERSITY, HSINCHU (TW)

(72) Inventor: JIUM MING LIN, HSINCHU (TW)

(21) Appl. No.: 14/301,648

(22) Filed: Jun. 11, 2014

(30) Foreign Application Priority Data
Jun. 11, 2013 (TW) 102120642

(51) Int. Cl. G01P 15/00

(52) U.S. Cl. CPC G01P 15/008
USPC 73/514.09

(57) ABSTRACT

A thermal convection type linear accelerometer includes a substrate and a first sensing device. The first sensing device includes two first temperature-sensing components and a first heater. The two first temperature-sensing components are disposed on the substrate. The first heater is disposed on the substrate. The first heater is located between the two first temperature-sensing components. The two first temperature-sensing components are higher than the first heater relative to the substrate.

### CROSS-REFERENCE TO RELATED APPLICATION

The present application is based on, and claims priority from, Taiwan Patent Application Serial Number 102120642, filed on Jun. 11, 2013, the disclosure of which is hereby incorporated by reference herein in its entirety.

### BACKGROUND OF THE INVENTION

1. Field of the Invention

The present invention relates to a thermal convection type linear accelerometer.

2. Description of the Related Art

U.S. Pat. No. 6,182,509 discloses a thermal convection type accelerometer, which comprises a silicon substrate, a heater, and a pair of temperature sensitive elements. The silicon substrate has a chamber. The heater and the pair of temperature sensitive elements are suspended over the chamber. The two temperature sensitive elements are equidistant from the heater.

In order to form a heater and two temperature sensitive elements extending across a chamber, a fabrication method initially forms an oxide layer on the substrate. Next, a polysilicon layer is formed on the oxide layer. Thereafter, an oxidation process is performed to form another oxide layer on the polysilicon layer. Subsequently, the polysilicon layer is patterned to form three polysilicon bridges. Afterward, another oxidation process is performed to form oxide layers on the lateral sides of the polysilicon bridges. Next, a deep cavity is formed by etching the substrate using EDP, which is a mixture of ethylenediamine, pyrocatechol, and water.

In the above-mentioned thermal convection type accelerometer, a symmetrical temperature gradient extending outwards from the heater is created when a current flows through the heater. When the thermal convection type accelerometer is accelerated, the two temperature sensitive elements sense different temperatures and exhibit different resistances. A linear acceleration value can be deduced by the resistance difference.

However, the present accelerometer responds slowly and is not sensitive enough.

### SUMMARY OF THE INVENTION

One embodiment of the present invention discloses a thermal convection type linear accelerometer. The thermal convection type linear accelerometer comprises a substrate and a first sensing device. The first sensing device comprises two first temperature-sensing components and a first heater. The two first temperature-sensing components are disposed on the substrate. The first heater is disposed on the substrate and between the two first temperature-sensing components. A height of at least one first temperature-sensing component is greater than a height of the first heater from the substrate.

In one embodiment, the two first temperature-sensing components have the same height.

In one embodiment, at least one first temperature-sensing component is distant from the substrate by a height of between 0.5 and 2 millimeters (but the disclosure is not limited to such an arrangement).

In one embodiment, the entire first heater and the entire first temperature-sensing components are on a surface of the substrate.

To better understand the above-described objectives, characteristics and advantages of the present invention, embodiments, with reference to the drawings, are provided for detailed explanations.

### BRIEF DESCRIPTION OF THE DRAWINGS

The invention will be described according to the appended drawings in which:

FIG. 1 is a schematic view showing a thermal convection type linear acceleration measurement system according to one embodiment of the present invention;

FIG. 2A is a schematic view showing a sensing device according one embodiment of the present invention;

FIG. 2B is a cross-sectional view along line 2-2 of FIG. 2A;

FIG. 3 is a schematic view showing a sensing device according another embodiment of the present invention;

FIG. 4A is a schematic view showing a thermal convection type linear accelerometer according to another embodiment of the present invention;

FIG. 4B is a cross-sectional view along line 4-4 of FIG. 4A;

FIG. 5A is a wireless radio frequency identification tag (RFID tag) device 16 of a thermal convection type linear accelerometer according to one embodiment of the present invention;

FIG. 5B is a cross-sectional view along line 5-5 of FIG. 5A;

FIG. 6 is a schematic view showing a sensing device of a thermal convection type linear accelerometer according to another embodiment of the present invention;

FIG. 7 is a schematic view showing a thermal convection type linear accelerometer according to another embodiment of the present invention; and

FIG. 8 is a schematic view showing a circuit of a thermal convection type linear accelerometer according to one embodiment of the present invention.

### DETAILED DESCRIPTION OF THE INVENTION

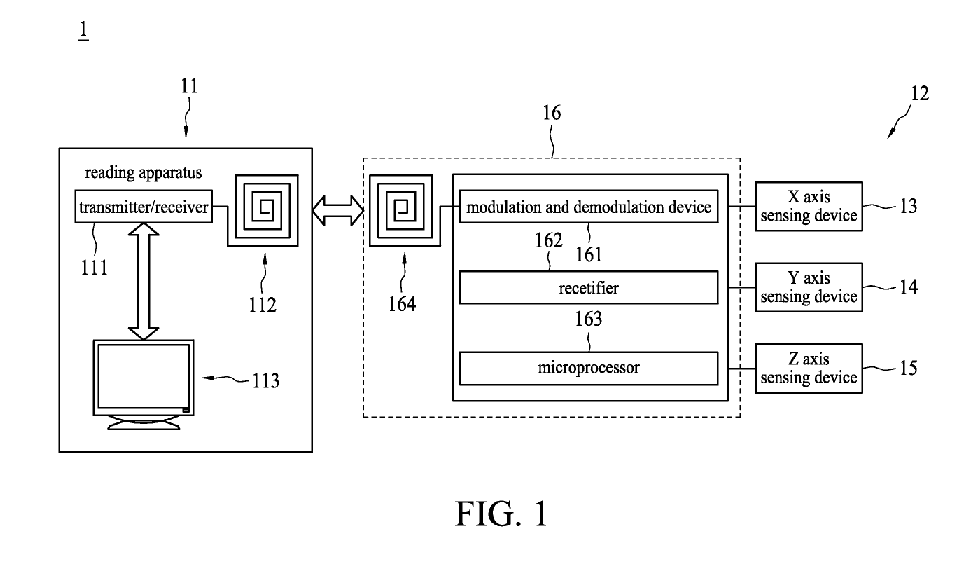

FIG. 1 is a schematic view showing a thermal convection type linear acceleration measurement system 1 according to one embodiment of the present invention. Referring to FIG. 1, a thermal convection type linear acceleration measurement system 1 comprises a reading apparatus 11 and a thermal convection type linear accelerometer 12. The thermal convection type linear accelerometer 12 is configured to measure linear acceleration data along at least one direction or axis. The thermal convection type linear accelerometer 12 is configured to wirelessly send measured linear acceleration data to the reading apparatus 11. In one embodiment, the thermal convection type linear accelerometer 12 utilizes RFID (radio frequency identification) technology to transmit linear acceleration data.

Referring to FIG. 1, the thermal convection type linear accelerometer 12 comprises at least one sensing device (13, 14 or 15) configured to measure acceleration data along a direction or axis. In one embodiment, the thermal convection type linear accelerometer 12 comprises two sensing devices that are configured to respectively measure linear acceleration data along two directions. In one embodiment, the thermal convection type linear accelerometer 12 comprises an X-axis linear acceleration-sensing device 13, a Y-axis linear acceleration-sensing device 14, and a Z-axis acceleration-sensing device 15.

The thermal convection type linear accelerometer 12 may comprise a plurality of sensing devices. In one embodiment, the plurality of sensing devices are separated or distinct devices. In one embodiment, the plurality of sensing devices are integrated together.

The thermal convection type linear accelerometer 12 may further comprise an RFID tag device 16, which can connect to at least one sensing device (13, 14 or 15).

In one embodiment, the RFID tag device 16 is used to communicate with the reading apparatus 11. In one embodiment, the RFID tag device 16 is used to control at least one sensing device (13, 14 or 15).

The RFID tag device 16 can be operated in an active or passive mode. In one embodiment, the RFID tag device 16 is in a passive mode when the thermal convection type linear accelerometer 12 does not conduct measurement. In one embodiment, the thermal convection type linear accelerometer 12 is activated when the RFID tag device 16 receives a microwave signal from the reading apparatus 11. In one embodiment, if the signal received by the RFID tag device 16 is weak, the active mode is activated when the RFID tag device 16 is going to send signals to the reading apparatus 11; otherwise, measured data is sent in a passive mode.

In one embodiment, the RFID tag device 16 comprises a rectifier 162. When the RFID tag device 16 is operated in a passive mode, the electrical power required by the RFID tag device 16 is obtained by using the rectifier 162 to convert RF energy received by an antenna. In one embodiment, in order to maintain the stability of rectified electrical power, a capacitor is additionally disposed for the thermal convection type linear accelerometer 12.

In one embodiment, the RFID tag device 16 may comprise an oscillation circuit configured to generate clock signals for the operation of the RFID tag device 16. The oscillation circuit may additionally connect to a resistor and a capacitor. In one embodiment, the oscillation circuit is a multi-vibrator, which forms with resistors and capacitors and is used to generate clock signals.

Referring to FIG. 1, the RFID tag device 16 may comprise a microprocessor 163. In one embodiment, the microprocessor 163 is configured to control at least one sensing device (13, 14 or 15). In one embodiment, the microprocessor 163 is used to control the RFID tag device 16. In one embodiment, the microprocessor 163 is used to control the entire thermal convection type linear accelerometer 12.

The RFID tag device 16 may comprises a modulation and demodulation device 161 configured for wireless communication. In addition, the RFID tag device 16 may comprise an antenna 164 coupled with the modulation and demodulation device 161 and configured for wireless communication.

In one embodiment, the modulation and demodulation device 161, the rectifier 162, and the microprocessor 163 are integrated in a chip. In one embodiment, the modulation and demodulation device 161, the rectifier 162, and the microprocessor 163 are individual components respectively.

Referring to FIG. 1, the reading apparatus 11 may comprise a transmitter/receiver 111 and an antenna 112, which are used together for wireless communication.

The reading apparatus 11 may comprise a monitoring apparatus 113, which is configured to monitor the linear accelerometer 12.

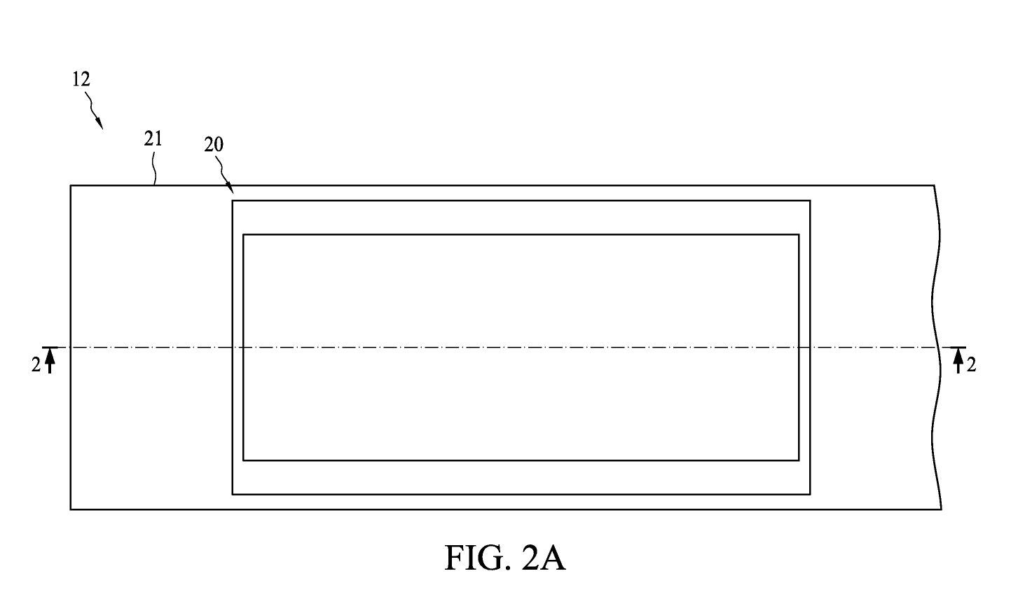

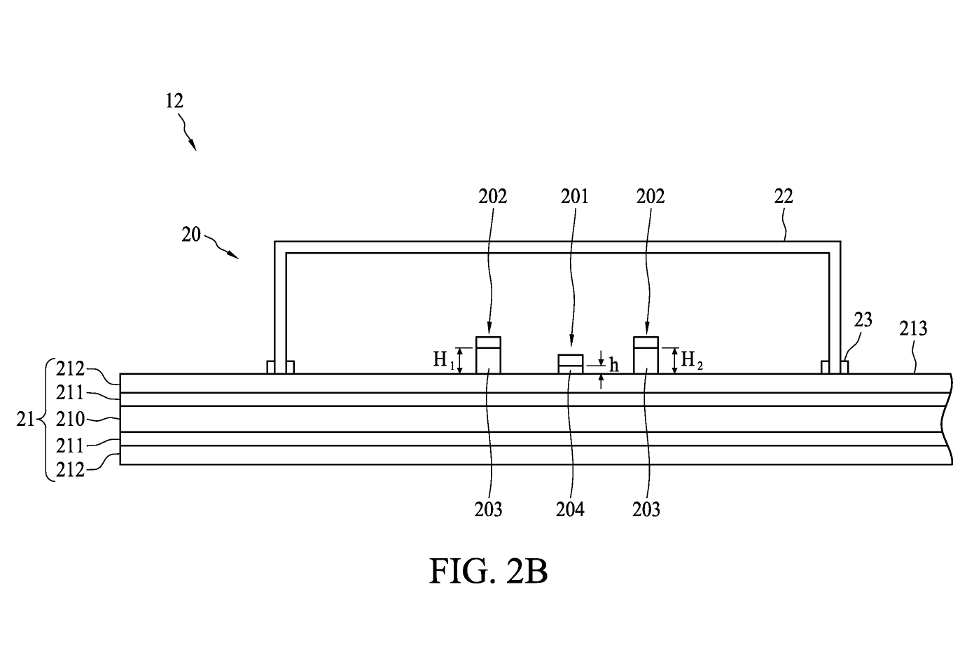

FIG. 2A is a schematic view showing a sensing device according one embodiment of the present invention. FIG. 2B is a cross-sectional view along line 2-2 of FIG. 2A. The sensing device 20 of the embodiment of FIGS. 2A and 2B may be an X-axis linear acceleration-sensing device, a Y-axis linear acceleration-sensing device, a Z-axis linear acceleration-sensing device, or a linear acceleration-sensing device along another axis. Referring to FIGS. 2A and 2B, the linear accelerometer 12 comprises a substrate 21 and a sensing device 20 disposed on the substrate 21.

Referring to FIG. 2B, the substrate 21 is used to support the sensing device 20. In one embodiment, the substrate 21 comprises a circuit board. In one embodiment, the substrate 21 comprises a printed circuit board. In one embodiment, the substrate 21 comprises a flexible plastic material. Since the plastic material has low thermal conductivity coefficients, heat generated by the linear accelerometer 12 is not easily dissipated and the energy consumption is less. In one embodiment, the flexible plastic material comprises polyethylene terephthalate (PET) or polyimide (PI).

In one embodiment, the substrate 21 comprises a base material 210 and two silicon dioxide layers 211. The base material 210 can be flexible, and the two silicon dioxide layers 211 are respectively vapor-deposited on the two opposite sides of the base material 210. In one embodiment, the silicon dioxide layer 211 has a thickness of between 1 and 10 micrometers (but the disclosure is not limited to such an arrangement). In one embodiment, the substrate 21 may further comprise two photo-resist layers 212, which are respectively formed on the two silicon dioxide layers 211. In one embodiment, the photo-resist layer 212 can have a thickness of from 20 to 100 micrometers (but the disclosure is not limited to such an arrangement).

Referring to FIG. 2B, the sensing device 20 comprises a heater 201 and two temperature-sensing components 202. The heater 201 is located between the two temperature-sensing components 202. The heater 201 and the two temperature-sensing components 202 are formed on the substrate 21. In one embodiment, at least one temperature-sensing component 202 is relative to the substrate 21 by a height (H₁ or H₂) different from a height (h) of the heater 201 relative to the substrate 21. In one embodiment, at least one temperature-sensing component 202 is relative to the substrate 21 by a height (H₁ or H₂) greater than a height (h) of the heater 201 relative to the substrate 21. In one embodiment, at least one temperature-sensing component 202 is relative to the substrate 21 by a height (H₁ or H₂) greater than a height (h) of the heater 201. The increased height (H₁ or H₂) of at least one temperature-sensing component 202 relative to the substrate 21 can improve the sensitivity of the sensing device 20. In comparison, heaters and temperature sensors of traditional linear accelerometers are all on the same level such that the accelerometers have lower sensitivities. In one embodiment, the two temperature-sensing components 202 are relative to the substrate 21 by heights (H₁ and H₂) greater than that of the heater 201 relative to the substrate 21. In one embodiment, the two temperature-sensing components 202 are distant from the substrate 21 by heights (H₁ and H₂) greater than a height (h) of the heater 201. In one embodiment, the heights (H₁ and H₂) of the two temperature-sensing components 202 are the same. In one embodiment, the heights (H₁ and H₂) of the two temperature-sensing components 202 are different. In one embodiment, at least one temperature-sensing component 202 is distant from the substrate 21 by a height (H₁ or H₂) of between 0.5 and 2 millimeters (but the disclosure is not limited to such an arrangement). In one embodiment, the height (h) of the heater 201 is less than 0.5 millimeters (but the disclosure is not limited to such an arrangement).

Referring to FIG. 2B, the substrate 21 includes a surface 213. The entire heater 201 and the entire two temperature-sensing components 202 are formed on the surface 213, not over a cavity or chamber. Moreover, the sensing device 20 does not include any movable structure, and therefore, the cost of the linear accelerometer 12 can be significantly reduced and the reliability of the linear accelerometer 12 can be considerably increased.

In one embodiment, the heater 201 can have an elongated shape.

In one embodiment, the heater 201 comprises chromium and nickel. In one embodiment, the heater 201 comprises stacked chromium and nickel layers, as shown in FIG. 2B.

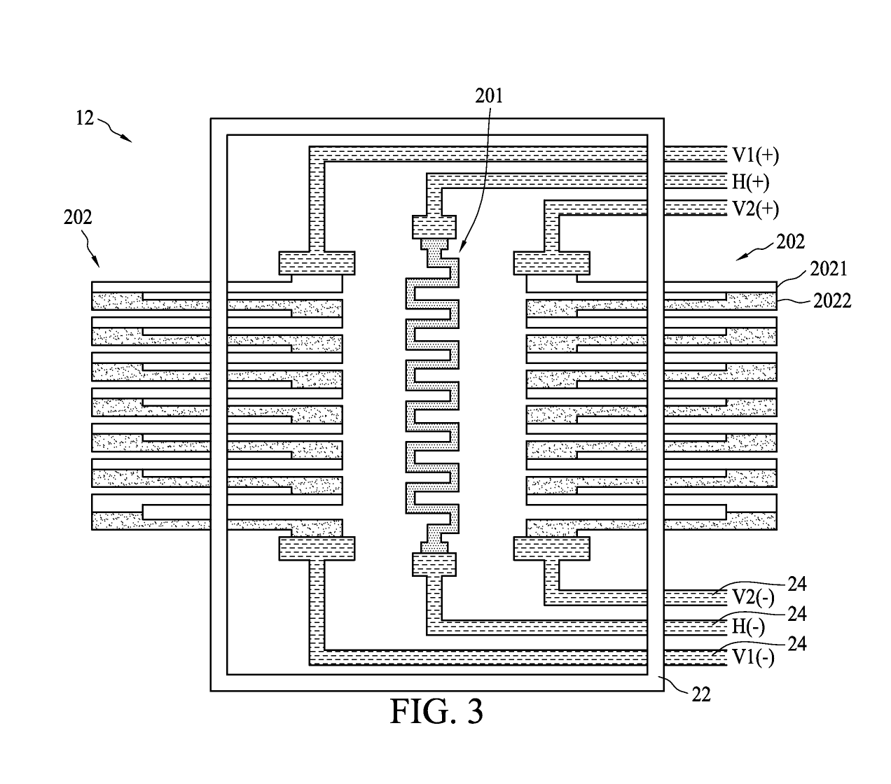

In one embodiment, the temperature-sensing component 202 comprises a p-type amorphous silicon layer. In one embodiment, the temperature-sensing component 202 comprises a zig-zag shape, which can increase resistance, and prevent the generation of unnecessary heat that increases temperature and adversely affects the sensitivity of the sensing device. In one embodiment, the temperature-sensing component 202 comprises an E, K, T, or J type thermopile. In one embodiment, the temperature-sensing component 202 comprises chromium of between 12% and 19% and nickel of between 81% and 88%. In one embodiment, as shown in FIG. 3, the temperature-sensing component 202 comprises two portions (2021 and 2022), wherein one portion of the temperature-sensing component 202 comprises chromium of 90-91% and nickel of 9-10%, and another portion of the temperature-sensing component 202 comprises nickel of 16-17%, aluminum of 33-34%, manganese of 33-34%, and silicon of 16-17%. In one embodiment, as shown in FIG. 3, the temperature-sensing component 202 comprises two portions (2021 and 2022), wherein one portion of the temperature-sensing component 202 comprises chromium of 90-91% and nickel of 9-10%, and another portion of the temperature-sensing component 202 comprises nickel of 45-46% and copper of 54-55%. In one embodiment, as shown in FIG. 3, the temperature-sensing component 202 comprises two portions (2021 and 2022), wherein one portion of the temperature-sensing component 202 comprises nickel of 45-46% and copper of 54-55%, and another portion of the temperature-sensing component 202 comprises copper. In one embodiment, as shown in FIG. 3, the temperature-sensing component 202 comprises two portions (2021 and 2022), wherein one portion of the temperature-sensing component 202 comprises nickel of 45-46% and copper of 54-55%, and another portion of the temperature-sensing component 202 comprises iron.

Referring to FIG. 2B, the heater 201 and the sensing device 20 may comprise a plurality of support elements 204 and 203, respectively. The support elements 204 and 203 are formed on the substrate 21. The plurality of support elements 203 are formed correspondingly to the temperature-sensing components 202. Each support element 203 is formed between one corresponding temperature-sensing component 202 and the substrate 21 so as to support the corresponding temperature-sensing component 202. In one embodiment, a thickness (H₁ or H₂) of the support element 203 is between 0.5 and 2 millimeters (but the disclosure is not limited to such an arrangement), and the height h of the heater 201 is less than the thickness (H₁ or H₂) of the support element 203. In one embodiment, in the same sensing device 20, the thicknesses (H₁ and H₂) of two support elements 203 are different. In one embodiment, in the same sensing device 20, the thicknesses (H₁ and H₂) of two support elements 203 are identical.

In one embodiment, the substrate 21 includes a surface 213 and each support element 203 is entirely formed on the surface 213 of the substrate 21, not over a cavity or chamber. In one embodiment, the heater 201 is directly formed on the surface 213 of the substrate 21. In one embodiment, the heater 201 is not directly formed on the surface 213 of the substrate 21.

In one embodiment, the support elements 203 and 204 comprises a material with high thermal capacity, such as aluminum nitride.

Referring to FIGS. 2A and 2B, the linear accelerometer 12 comprises a cover 22, which defines an enclosed space. The heater 201 of the sensing device 20 causes the occurrence of heat convection in the enclosed space. In one embodiment, an inert gas, such as xenon, can be introduced into the inside of the cover 22. In one embodiment, an adhesive 23 is applied to attach the cover 22 onto the substrate 21. In one embodiment, the cover 22 can have a rectangular appearance. In one embodiment, the cover 22 can have a rectangular interior.

Referring to FIG. 3, in one embodiment, the heater 201 comprises a meandering configuration.

In one embodiment, the temperature-sensing component 202 may be formed by a plurality of series-connected K type thermocouples. The thermocouple comprises the connected two portions 2021 and 2022. The K type thermocouple includes a positive electrode made of Chromel including nickel and chrome, and a negative electrode made of Alumel including nickel, aluminum, manganese, and silicon. The method for forming a plurality of series-connected K type thermocouples is disclosed in U.S. Ser. No. 13/685,398, the relevant contents of which are incorporated herein for reference.

In one embodiment, the temperature-sensing component 202 may be formed by a plurality of series-connected E type thermocouples. The E type thermocouple has the same nickel-chrome positive electrode as the K type thermocouple. The E type thermocouple includes a negative electrode, which is made of nickel copper alloy. The nickel copper alloy includes nickel of 45-46% and copper of 54-55%. The method for forming a plurality of series-connected E type thermocouples is similar to the method for forming a plurality of series-connected K type thermocouples.

In one embodiment, the temperature-sensing component 202 may be formed by a plurality of series-connected T type thermocouples. The T type thermocouple includes a negative electrode made of nickel-copper alloy (similar to the composition of the negative electrode of the E type thermocouple) and a positive electrode made of copper. The method for forming a plurality of series-connected T type thermocouples is similar to that for forming a plurality of series-connected K type thermocouples.

In one embodiment, the temperature-sensing component 202 may be integrally formed by a plurality of series-connected J type thermocouples. The J type thermocouple can have a negative electrode made of nickel copper alloy (similar to the composition of the negative electrode of the T type thermocouple) and a positive electrode made of iron.

Referring to FIG. 3, the temperature-sensing component 202 is formed by a plurality of series-connected thermocouples, wherein each thermocouple partially protrudes outside of the cover 22. The portion of the thermocouple protruding outside of the cover 22 can be used for ambient temperature calibration so as to improve the accuracy of the linear accelerometer 12.

Referring to FIG. 3, the linear accelerometer 12 may further comprise a plurality of metal lines 24. Each metal line 24 connects to one end of a corresponding heater 201 or temperature-sensing component 202.

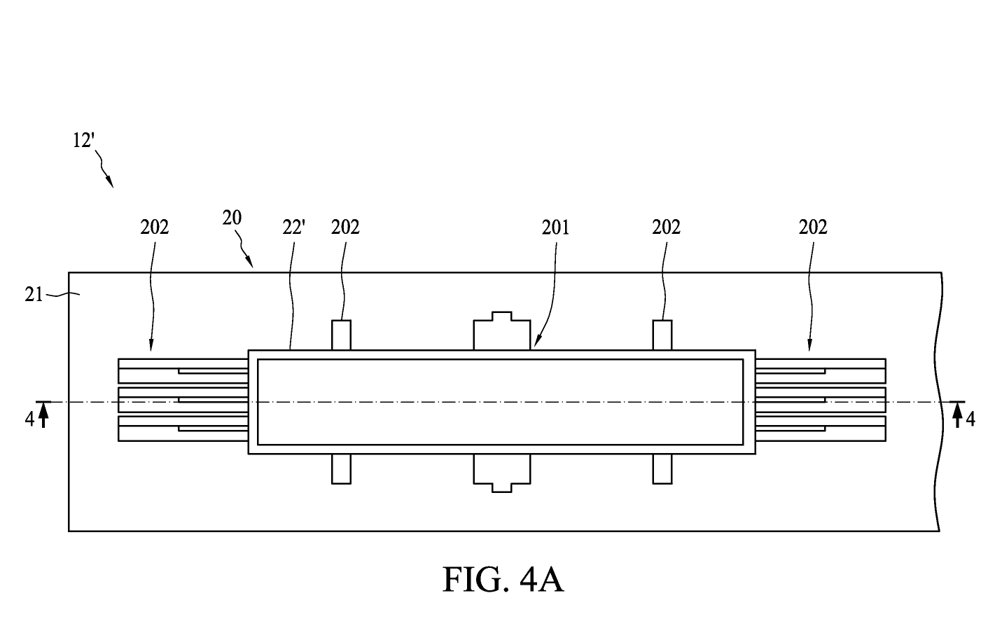

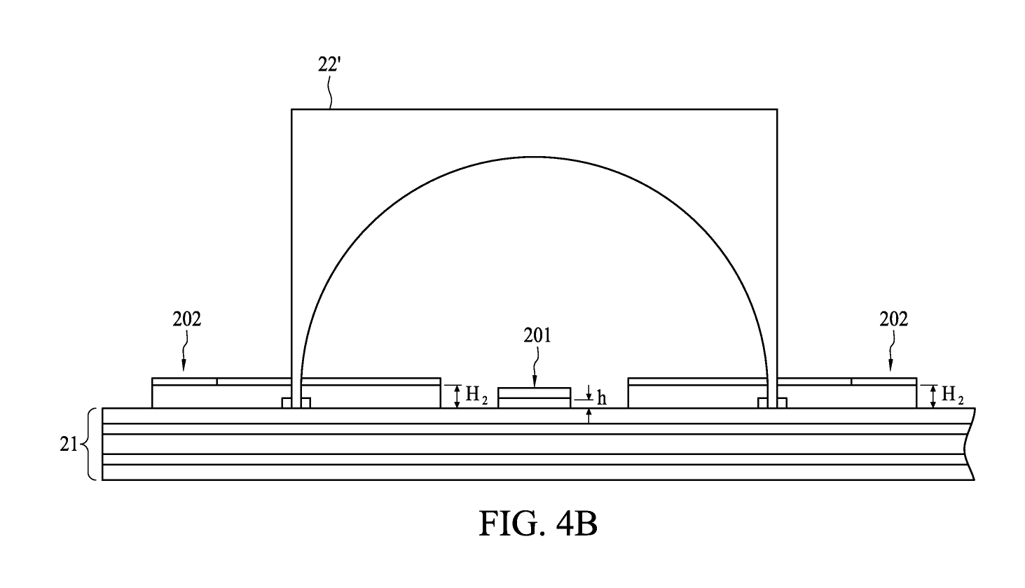

FIG. 4A is a schematic view showing a thermal convection type linear accelerometer 12′ according to another embodiment of the present invention. FIG. 4B is a cross-sectional view along line 4-4 of FIG. 4A. Referring to FIGS. 4A and 4B, a thermal convection type linear accelerometer 12′ comprises at least one sensing device 20 configured to detect a linear acceleration along a corresponding axis. The sensing device 20 comprises two temperature-sensing components 202 and a heater 201 disposed between the two temperature-sensing components 202. The thermal convection type linear accelerometer 12′ comprises a cover 22′, which is disposed on a substrate 21 and defines an enclosed space. The heater 201 and the temperature-sensing components 202 partially extend under the cover 22′. The heater 201 can induce the occurrence of heat convection in the cover 22′. The temperature-sensing components 202 can measure a neighboring temperature change when the linear accelerometer 12′ moves. In one embodiment, the cover 22′ defines a hemi-cylindrical chamber or a hemi-spherical chamber, which allows internal fluid to flow more smoothly and causes the linear accelerometer 12′ to be more responsive and sensitive. Referring to FIGS. 3, 4A and 4B, in another embodiment of the present invention, a support element 203 is disposed below the temperature-sensing component 202. The support element 203 comprises a material with high thermal capacity, such as aluminum nitride.

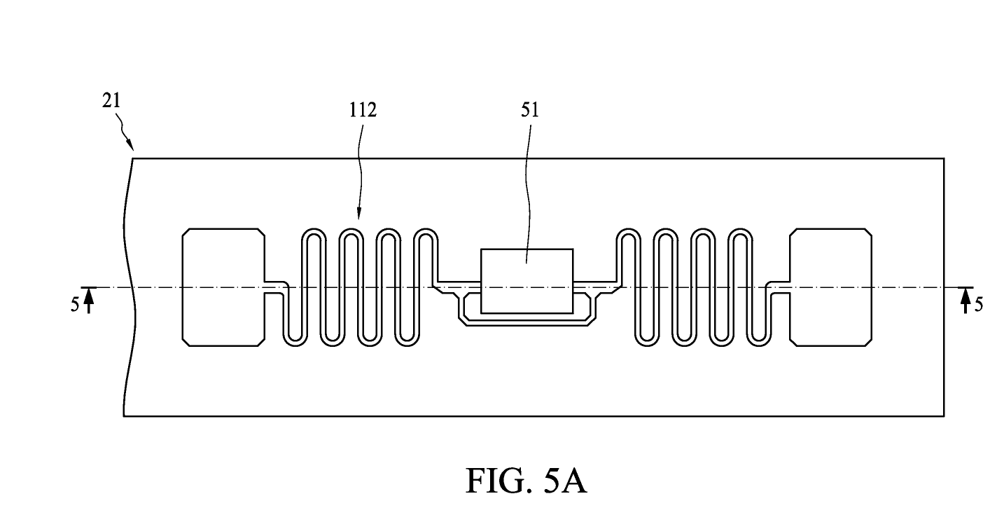

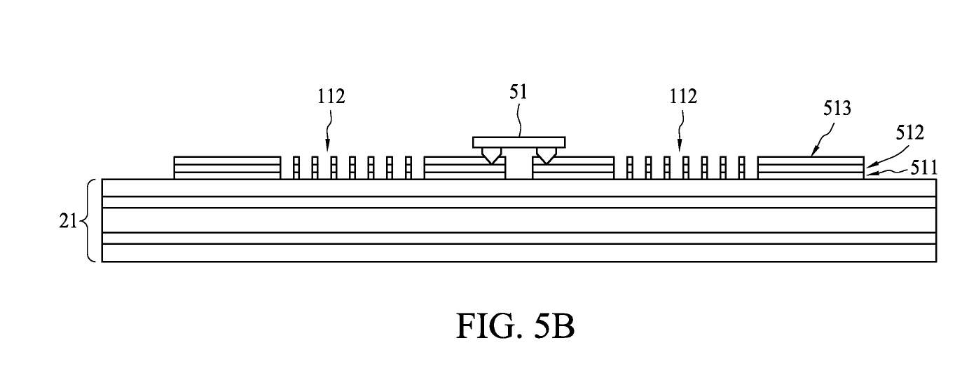

FIG. 5A is a wireless radio frequency identification tag (RFID tag) device 16 of a thermal convection type linear accelerometer 12 according to one embodiment of the present invention. FIG. 5B is a cross-sectional view along line 5-5 of FIG. 5A. Referring to FIGS. 1, 5A, and 5B, an RFID tag device 16 and at least one sensing device 20 are formed together on the same substrate 21, but the disclosure is not limited to such an arrangement. The RFID tag device 16 comprises a chip 51 and an antenna 112. The antenna 112 can be formed on the substrate 21. The antenna 112 can be an RFID antenna. The chip 51 can electrically connect to the antenna 112.

The chip 51 is configured to send signals to the reading apparatus 11 via the antenna 112, or receives signals from the reading apparatus 11. The chip 51 can use received signals to generate electrical power. The chip 51 can generate a clock signal. The chip 51 can operate in an active or passive mode. The chip 51 can electrically connect to at least one sensing device 20 and control the sensing device 20. The chip 51 can receive a measured signal generated by at least one sensing device 20. The chip 51 may control a current flowing through the heater 201 of each sensing device 20 so as to induce the occurrence of suitable and different heat convection in each sensing device 20. The chip 51 can control each temperature-sensing component 202 of each sensing device 20 for calibration. In one embodiment, metal lines shown in FIG. 3 are used to connect to the chip 51.

In one embodiment, the antenna 112 comprises nickel and chromium. In one embodiment, the antenna 112 comprises gold, nickel, and chromium.

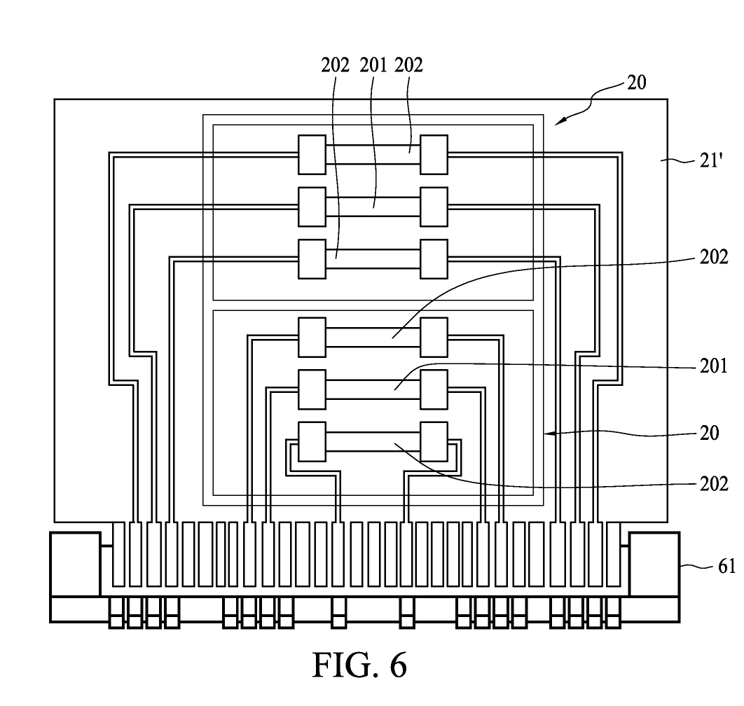

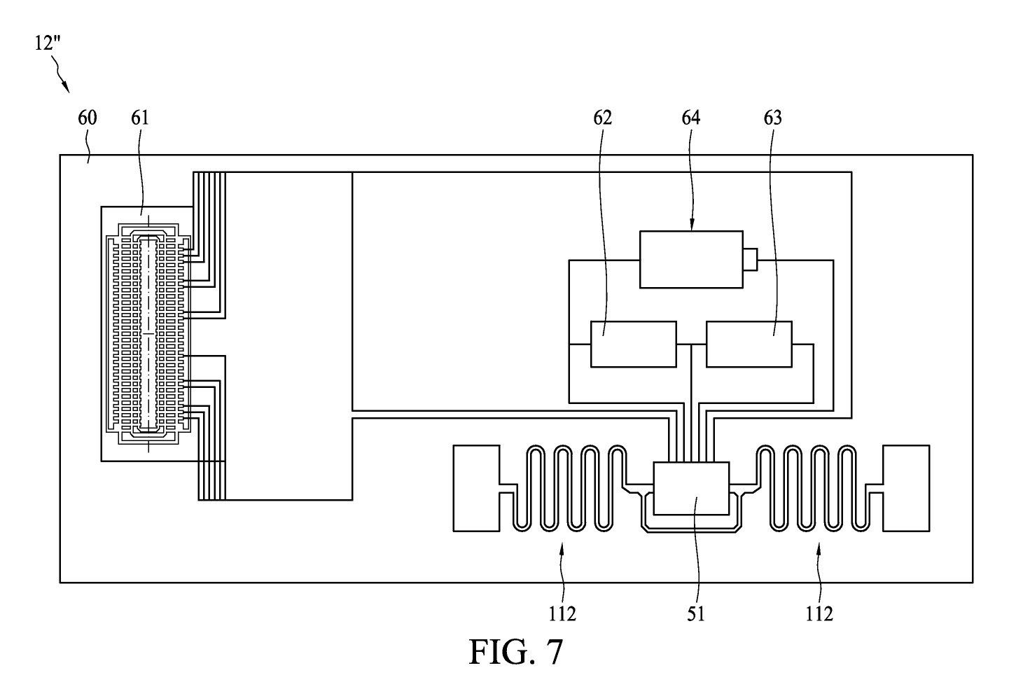

FIG. 6 is a schematic view showing a sensing device 20 of a thermal convection type linear accelerometer 12″ according to another embodiment of the present invention. FIG. 7 is a schematic view showing a thermal convection type linear accelerometer 12″ according to another embodiment of the present invention. As shown in FIGS. 6 and 7, a thermal convection type linear accelerometer 12″ can be inserted into a connector 61 on a substrate 60 such that the thermal convection type linear accelerometer 12″ can measure the linear acceleration along a direction (or, Z-axis) perpendicular to the substrate 60.

The thermal convection type linear accelerometer 12″ comprises at least one sensing device 20 and a substrate 21′. The at least one sensing device 20 can be disposed on the substrate 21′. In one embodiment, the substrate 21′ comprises a circuit board or printed circuit board. In one embodiment, the substrate 21′ comprises a hard base material.

The substrate 21′ can include a plurality of pads thereon. The plurality of pads can correspondingly contact the terminals of the connector 61. At least one sensing device 20 electrically connects to the plurality of pads and electrically connects to the chip 51 on the substrate 60 through the terminals of the connector 61 and circuits on the substrate 60.

Referring to FIG. 7, in one embodiment, the substrate 60 comprises a flexible plastic substrate. In one embodiment, a sensing device is disposed on the substrate 60 and configured to measure the linear acceleration along a direction in parallel to a surface of the substrate 60. In one embodiment, a plurality of sensing devices are disposed on the substrate 60 and configured to measure the linear accelerations along different directions in parallel to a surface of the substrate.

Referring to FIG. 7, in one embodiment, a resistor 62 can be formed on the substrate 60. The resistor 62 can be connected to the chip 51. The resistor 62 is used in a circuit that can amplify a voltage signal generated by a sensing device if the voltage signal is small. In one embodiment, a capacitor 63 can be formed on the substrate 60. The capacitor 63 may connect to the chip 51 as an external capacitor for the chip 51. In one embodiment, a battery 64 can be electrically connected to circuits on the substrate 60 to provide electrical power for the operation of the thermal convection type linear accelerometer 12″.

Referring to FIG. 6, two sensing devices 20 are formed on the substrate 21′. The temperature-sensing components 202 of the two sensing devices 20 are connected to a Wheatstone bridge. With the Wheatstone bridge, the thermal convection type linear accelerometer 12″ can generate a difference of voltage that can be used to determine the acceleration when the thermal convection type linear accelerometer 12″ moves under the acceleration. The detailed connection of the two sensing devices 20 is disclosed in U.S. Ser. No. 13/685,398, the relevant contents of which are incorporated herein for reference.

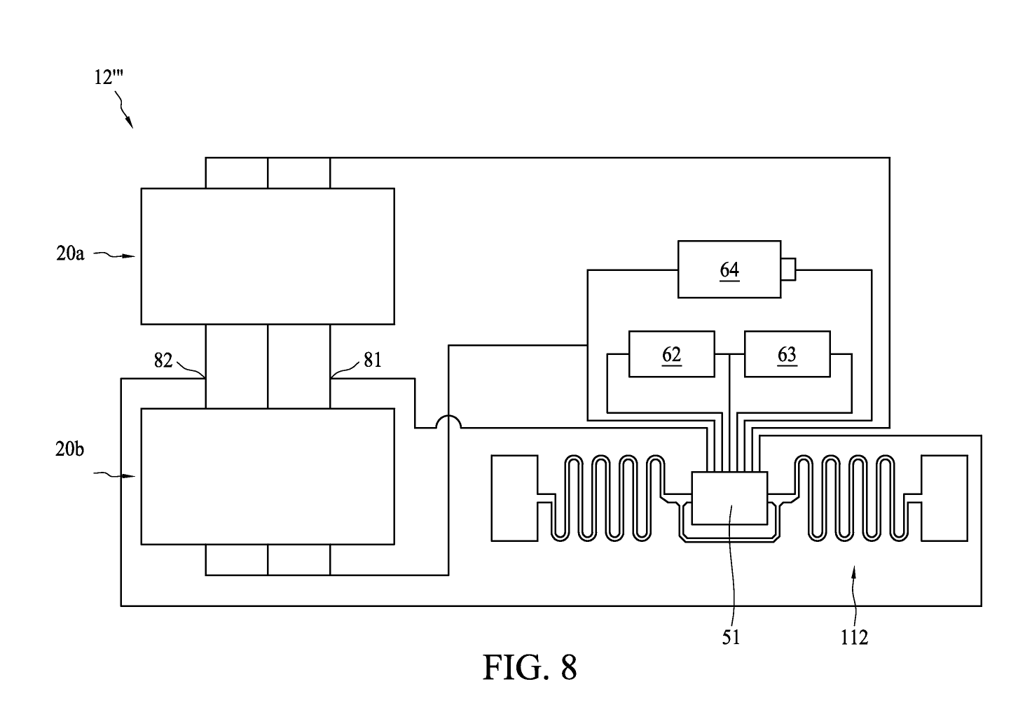

FIG. 8 is a schematic view showing a circuit of a thermal convection type linear accelerometer 12′ according to one embodiment of the present invention. As shown in FIG. 8, a thermal convection type linear accelerometer 12′″ comprises two sensing devices (20a and 20b) configured to measure an acceleration along a direction, for example, an X-axis direction, Y-axis direction, or Z-axis direction. The sensing devices (20a and 20b) are connected to a chip 51, which can provide currents for the sensing devices (20a and 20b). The temperature-sensing components of the sensing devices (20a and 20b) are connected to a Wheatstone bridge, and the serial connection points (81 and 82) between the temperature-sensing components connect to the chip 51 such that the chip can obtain a difference of voltage. The detailed connection of the two sensing devices is disclosed in U.S. Ser. No. 13/685,398, the relevant contents of which are incorporated herein for reference.

Referring to FIGS. 2A, 2B, 5A, and 5B, the description below illustrates a method for forming a thermal convection type linear accelerometer according to one embodiment of the present invention. The method initially vapor-deposits a material with high thermal capacity on the front side of a flexible substrate by a thickness of 0.5 to 2 millimeters (but the disclosure is not limited to such an arrangement). The deposited material is used for forming structures for supporting temperature-sensing components. The material may be aluminum nitride. Thereafter, the substrate is dried. Next, a first mask is used and a photolithography process is applied to form support elements for supporting temperature-sensing components on the front side of the substrate.

Subsequently, a mixture of a p-type impurity and silicon powders is vapor-deposited by using an electron gun to form a p-type amorphous silicon layer with a thickness of between 100 and 250 micrometers (but the disclosure is not limited to such an arrangement). Afterward, the first mask and a photolithography process are applied to form p-type amorphous silicon structures on the front side of the substrate. A laser is applied for annealing in order to transform p-type amorphous silicon structures into poly-silicon structures, which are used as temperature-sensing components. In one embodiment, if two temperature-sensing components are different in height, their support elements can be formed separately.

Furthermore, chromium and nickel layers 511 and 512 are vapor-deposited on the substrate 21 by an electron gun. Moreover, a second mask and a photolithography process are applied to define a heater 201, RFID antenna 112 and circuits connecting to electrical power; and used for signal transmission on the chromium and nickel layers 511 and 512.

Thereafter, an electroless plating process is applied to form a gold layer 513 on the chromium and nickel layers 511 and 512 of the RFID antenna 112 and the circuits connecting to electrical power; and used for signal transmission by a thickness of 0.1 to 0.5 micrometers (but the disclosure is not limited to such an arrangement). Next, the photo-resist is removed.

Subsequently, a screen-printing process is applied to form a layer of adhesive around a linear accelerometer module as a dam bar. Moreover, a cover encases the linear accelerometer module, and an inert gas, such as xenon, is filled.

Next, a chip is flip chip bonded onto the feed terminals of the RFID antenna and pads connecting to an electrical power and circuits for signal transmission. A thermal compression method is used to fix the chip. An under-fill is then applied under the chip to increase the adherence.

Furthermore, a battery socket and a spring is disposed on the substrate for installation of a battery. To protect the chip and circuits from contamination, another flexible substrate can be used to cover the substrate, but not the battery socket.

The above-described embodiments of the present invention are intended to be illustrative only. Numerous alternative embodiments may be devised by persons skilled in the art without departing from the scope of the following claims.

What is claimed is:

1. A thermal convection type linear accelerometer comprising:
a substrate; and
a first sensing device comprising:
two first temperature-sensing components disposed on the substrate; and
a first heater disposed on the substrate and between the two first temperature-sensing components, wherein a height of at least one of the two first temperature-sensing components relative to the substrate is greater than a height of the first heater relative to the substrate.

2. The thermal convection type linear accelerometer of claim 1, wherein the height of at least one of the two first temperature-sensing components relative to the substrate is between 0.5 and 2 millimeters.

3. The thermal convection type linear accelerometer of claim 1, wherein the substrate comprises a surface, and the whole first heater and the whole two first temperature-sensing components are on the surface.

4. The thermal convection type linear accelerometer of claim 1, further comprising a second sensing device, which comprises:
two second temperature-sensing components disposed on the substrate; and
a second heater disposed on the substrate and between the two second temperature-sensing components, wherein a height of the two second temperature-sensing components relative to the substrate is greater than that of the second heater relative to the substrate;
wherein the first sensing device and the second sensing device are configured to measure linear accelerations in different directions.

5. The thermal convection type linear accelerometer of claim 4, wherein the height of the two second temperature-sensing components is between 0.5 and 2 millimeters.

6. The thermal convection type linear accelerometer of claim 5, wherein the substrate comprises a surface, and the whole second heater and the whole second temperature-sensing components are on the surface.

7. The thermal convection type linear accelerometer of claim 6, further comprising a third sensing device, which comprises:
two third temperature-sensing components; and
a third heater disposed between the two third temperature-sensing components, wherein the two third temperature-sensing components and the third heater are arranged in a direction perpendicular to the substrate.

8. The thermal convection type linear accelerometer of claim 7, further comprises an additional substrate, on which the two third temperature-sensing components and the third heater are disposed, wherein a height of the two third temperature-sensing components relative to the substrate is greater than that of the third heater relative to the substrate.

9. The thermal convection type linear accelerometer of claim 8, further comprises a plurality of support elements, wherein each support element is disposed between the first temperature-sensing component and the substrate, the second temperature-sensing component and the substrate, or the third temperature-sensing component and the substrate, wherein each support element includes a thickness between 0.5 and 2 millimeters.

10. The thermal convection type linear accelerometer of claim 9, wherein each support element comprises aluminum nitride.

11. The thermal convection type linear accelerometer of claim 10, further comprising a connector disposed on the substrate, wherein the additional substrate is inserted into the connector.

12. The thermal convection type linear accelerometer of claim 11, wherein each of the first, second, and third heaters comprises chromium of between 12% and 19% and nickel of between 81% and 88%.

13. The thermal convection type linear accelerometer of claim 12, comprising a radio frequency identification tag device connecting to the first, second, and third sensing devices.

14. The thermal convection type linear accelerometer of claim 13, wherein the first, second, and third temperature-sensing components comprises p-type amorphous silicon.

15. The thermal convection type linear accelerometer of claim 13, wherein the first, second, and third temperature-sensing components comprises an E, K, T, or J type thermopile.

16. The thermal convection type linear accelerometer of claim 1, wherein the height of the at least one of the two first temperature-sensing components is greater than a thickness of the first heater.
